(19) United States
(12) Patent Application Publication
(10) Pub. No.: US 2006/0290624 A1
(43) Pub. Date: Dec. 28, 2006

(54) Backlighting apparatus and method

(75) Inventor: Ian Ashdown, West Vancouver (CA)

Correspondence Address: FOLEY & LARDNER, 2029 CENTURY PARK EAST, SUITE 3500, LOS ANGELES, CA, 90067, US

(73) Assignee: TIR Systems Ltd.

(21) Appl. No.: 11/449,564

(22) Filed: Jun. 8, 2006

Related U.S. Application Data
(60) Provisional application No. 60/688,895, filed on Jun. 8, 2005.

(51) Int. Cl. G09G 3/32

(52) U.S. Cl. 345/83

(57) ABSTRACT

The present invention provides a method and apparatus for generating light having a desired chromaticity, wherein two or more light-emitting elements which emit light having a dominant wavelength different from the dominant wavelength of a desired chromaticity can be used to generate light having the desired chromaticity. In particular, the dominant wavelength of one light-emitting element is selected to be greater than that of the dominant wavelength of the desired chromaticity and the dominant wavelength of a second light-emitting element is selected to be less than the dominant wavelength of the desired chromaticity. Two or more light-emitting elements configured in this manner can be employed to generate one of each of the three or more display primaries required for a specific lighting application, for example backlighting of a display panel.

### CROSS-REFERENCE TO RELATED PATENT APPLICATIONS

This application is a An application claiming the benefit under 35 USC 119(e) U.S. Application 60/688,895, filed Jun. 8, 2005, incorporated herein by reference in its entirety.

### FIELD OF THE INVENTION

The present invention relates to displays, and more particularly to backlighting of display panels using light-emitting devices.

### BACKGROUND

The first industry standards for colour video displays were established by the Federal Communications Commission in 1953 through the National Television Standards Committee (NTSC). These standards included specific CIE 1931 xy chromaticities, (i.e., colours) for the red, green, and blue phosphors, or generically the “primaries” used in the cathode ray tubes (CRTs) to ensure that colour reproduction of broadcast images was consistent regardless of the CRT manufacturer.

Phosphor technology for CRT displays has advanced in the half-century since the NTSC specifications were published. In North America, colour television primaries are now specified by the Society of Motion Picture Engineers (SMPTE 2004), while in Europe, television colour primaries are specified by the European Broadcast Union (EBU 1993) and high-definition television (HDTV) colour primaries are specified by the Radiocommunication Sector of the International Telecommunications Union (ITU 1990). The Reference display primary chromaticities as defined by each of these standards are provided in Table 1.

TABLE 1

| Standard | Red (x, y) | Green (x, y) | Blue (x, y) |
|---|---|---|---|
| NTSC | 0.670, 0.330 | 0.210, 0.710 | 0.140, 0.060 |
| SMPTE C | 0.630, 0.340 | 0.310, 0.595 | 0.155, 0.070 |
| EBU/ITU | 0.640, 0.330 | 0.290, 0.600 | 0.150, 0.060 |

These standards equally apply to the colour primaries of liquid crystal displays (LCDs), plasma screen displays, field emission displays (FEDs), micro-mirror digital light projectors (DLPs), and other colour television and computer monitor display technologies. For example, the colour primaries of LCDs refer to the white colour of the fluorescent lamp backlight as respectively filtered by red, green, and blue pixel microfilters, the polarizing films, the liquid crystal material, and the various layers of transparent support and diffusion materials. Therefore these primary chromaticities refer to the colour of the red, green, and blue pixels as observed by a viewer, and are thus independent of the display technology.

Having particular regard to colour creation, it is known that colour science is predicated on Grassman's three laws of colour additivity. The first law states that any colour C can be matched by a linear combination of three other colours R, G, and B, for example, SMPTE or EBU/ITU display primaries, provided that none of the three colours can be matched by a combination of the other two and can be defined as follows:
C=aR+bG+cB (1)
where a, b, and c are constants of proportionality.

Grassman's second law of colour additivity states that any two colours C₁ and C₂ can be matched by a linear combination of any three other colours R, G, and B that individually match the two colours C₁, and C₂. Wherein this law can be defined as follows:
C=dC₁+eC₂=(a₁+a₂)R+(b₁+b₂)G+(c₁+C₂)B (2)
where a₁, a₂, b₁, b₂, c₁, c₂, d, and e are constants of proportionality.

Grassman's third law states that colour matching persists at all luminance values within the range of photopic vision which can be defined as follows:
kC=k(dC₁+eC₂) (3)
where d, e, and k are constants of proportionality.

The above identified standards, namely NTSC, SMPTE and EBU/ITU, can place restrictive requirements on manufacturing tolerances for the primary chromaticities. For example, SMPTE 2004 specifies chromaticity tolerances of ±0.005 units for both x and y in the CIE 1931 chromaticity diagram, while EBU 1975 specifies that chromaticity variances should be less than ±0.003 units in the CIE 1960 uv Uniform Colour Space. These tolerances can provide a means for meeting needs for skin tone reproduction, for example.

While cold-cathode fluorescent lamps are commonly used to provide backlighting for LCD panels, some television manufacturers have recently introduced products that use a combination of red, green, and blue light-emitting diodes (LEDs) to generate white light for backlighting purposes. The primary advantage the colour LEDs offer is that they are narrowband emitters with spectral bandwidths of between approximately 15 and 35 nanometers (nm). As most of the broadband emission generated by fluorescent lamps must be blocked by colour filters in order to achieve the requisite primary chromaticities, the narrowband emissions generated by LEDs may not require filtering, and therefore LEDs may offer the opportunity of higher backlight efficiency and brighter displays.

In general, the colour LED chromaticities do not coincide with those specified by the SMPTE 10 and EBU/ITU 12 standards, as illustrated in FIG. 1. This, however, is not important as long as the colour gamut 14 defined by the red, green, and blue LED chromaticities exceeds that of these standards as illustrated in FIG. 1. It is important to note however that LED chromaticities vary widely, particularly for green and blue LEDs. Current manufacturing technologies require LED manufacturers to test each LED for dominant wavelength, which is a measure of its colour and subsequently “bin” the LED accordingly with like LEDs. Typical binning criteria for blue and green LEDs are 10 nm intervals for their dominant wavelength, which can result in chromaticity differences greatly in excess of SMPTE and EBU/ITU requirements.

Additional problems that can arise with the use of LEDs for backlighting occur due to temperature dependencies of LEDs. For example, the dominant wavelength of blue and green LEDs has a typical temperature coefficient of approximately 0.04 nm/° C., while for red LEDs it is approximately 0.05 nm/° C., where the temperature is that of the LED junction. Assuming that the LED backlighting is designed to be dimmed over a range of 10:1, an expected junction temperature variation in the range of 30° C. may be possible. This temperature range would result in a shift in the dominant wavelength for blue LEDs of approximately 1.2 nm and which results in a corresponding change in chromaticity which exceeds the SMPTE and EBU/ITU requirements.

A further problem with the use of LEDs for backlighting occurs due to spectral broadening with increasing LED junction temperature. The full width half maximum (FWHM) spectral bandwidth of red LED spectral distributions can be predicted by:
Δλ=1.25×10⁻⁷λ²T (4)
where the dominant wavelength λ is in nm and the LED junction temperature T is in Kelvin. The spectral broadening of blue and green LEDs can be ill-defined, but typically can exhibit similar behaviour. The result of this spectral broadening is a decrease in excitation purity, or saturation of the LED colour and can result in a further change in LED chromaticity.

Changes in LED chromaticities however, may not be a problem if: a) the resultant colour gamut fully encompasses the colour gamuts defined by the SMPTE or EBU/ITU primaries; and b) the display system includes a colour sensor to monitor the backlight chromaticity and continually adjusts the LED drive currents to maintain constant chromaticity for the displayed colours. These objectives may be achieved through careful colour binning of the LEDs by dominant wavelength, although this can be costly as only a small portion of the manufactured LEDs can be used for this purpose.

An advantage of LED backlighting is that it can offer the opportunity to achieve a larger colour gamut than is possible with CRT display phosphors and LCD panels that are backlit with cold-cathode fluorescent lamps. However, with this comes the need for stringent colour binning requirements for the LEDs, as the range of LED chromaticities must always encompass the specified colour gamut for the display device.

A further advantage of LED backlighting with colour feedback is that studio-quality CRT displays typically must be manually calibrated at frequent intervals to maintain colourimetric reproduction accuracy. LCD panels with LED backlighting and colour feedback can offer the possibility of self-calibrating displays. However, the need to allow for manufacturing tolerances in LED chromaticities and their temperature dependencies tends to restrict the colour gamut that can be achieved.

There is therefore an evident need for a method whereby the choice of LEDs is not limited to a small range of dominant wavelengths in order to achieve a desired colour gamut, and there is also an evident need for an apparatus and method for backlighting using light-emitting elements, wherein said colour gamut may be maintained despite LED chromaticity shifts due to changes in LED junction temperature, LED aging, and other factors.

### SUMMARY OF THE INVENTION

An object of the present invention is to provide a backlighting apparatus and method. In one aspect of the present invention there is provided a method for generating light having a desired primary chromaticity having a dominant wavelength, said method comprising the steps of: providing one or more first light-emitting elements for generating first light having a first dominant wavelength, said first dominant wavelength being greater than the dominant wavelength of the desired primary chromaticity; providing one or more second light-emitting elements for generating second light having a second dominant wavelength, said second dominant wavelength being less than the dominant wavelength of the desired primary chromaticity; and driving said one or more first light-emitting elements and said one or more second light-emitting elements, wherein combining the first light and second light creates light having the desired primary chromaticity.

In another aspect of the present invention there is provided an apparatus for generating light having a desired primary chromaticity having a dominant wavelength, said apparatus comprising: one or more first light-emitting elements for generating first light having a first dominant wavelength, said first dominant wavelength being greater than the dominant wavelength of the desired primary chromaticity; one or more second light-emitting elements for generating second light having a second dominant wavelength, said second dominant wavelength being less than the dominant wavelength of the desired primary chromaticity; a feedback system for monitoring a combination of the first light and the second light, said feedback system for generating feedback signals based thereon; and a control system operatively connected to the feedback system for receiving the feedback signals and for controlling activation of said one or more first light-emitting elements and one or more second light-emitting elements, wherein said control system activates the one or more first light emitting elements and the one or more second light-emitting elements in order that the combination of the first light and the second light creates light having the desired primary chromaticity; wherein the apparatus is adapted for connection to a source of power for activation of the one or more first light-emitting element and one or more second light-emitting elements.

In another aspect of the present invention there is provided a backlighting apparatus comprising: one or more first light-emitting elements for generating first light having a first dominant wavelength, said first dominant wavelength being greater than a desired first primary dominant wavelength and one or more second light-emitting elements for generating second light having a second dominant wavelength, said second dominant wavelength being less than the desired first primary dominant wavelength; one or more third light-emitting elements for generating third light having a third dominant wavelength, said third dominant wavelength being greater than a desired second primary dominant wavelength and one or more fourth light-emitting elements for generating fourth light having a fourth dominant wavelength, said fourth dominant wavelength being less than the desired second primary dominant wavelength; one or more fifth light-emitting elements for generating fifth light having a fifth dominant wavelength, said fifth dominant wavelength being greater than a desired third primary dominant wavelength and one or more sixth light-emitting elements for generating sixth light having a sixth dominant wavelength, said sixth dominant wavelength being less than the desired third primary dominant wavelength; a feedback system for monitoring a combination of the first light, second light, third light, fourth light, fifth light and sixth light, said feedback system for generating feedback signals based thereon; and a control system operatively connected to the feedback system for receiving the feedback signals and for controlling activation of said first, second, third, fourth, fifth and sixth light-emitting elements, wherein said control system activates the first, second, third, fourth, fifth and sixth light emitting elements in order that the combination of the first, second, third, fourth, fifth and sixth light creates light having a desired chromaticity; wherein the backlighting apparatus is adapted for connection to a source of power for activation of said first, second, third, fourth, fifth and sixth light-emitting elements.

### BRIEF DESCRIPTION OF THE FIGURES

FIG. 1 illustrates the colour gamut of colour display standards and typical LEDs on the CIE 1931 chromaticity diagram.

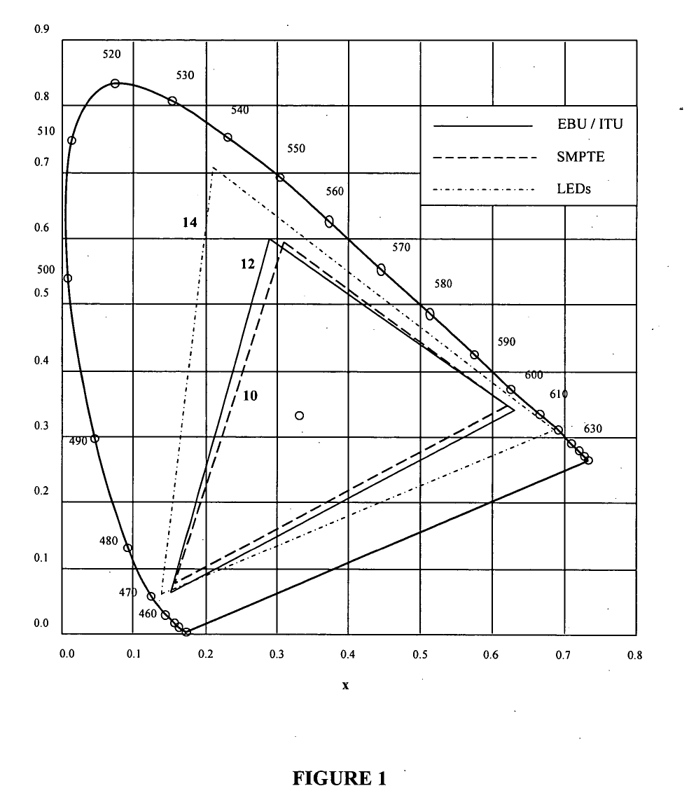

FIG. 2 illustrates Grassman's first and second laws of colour additivity.

FIG. 3 illustrates the ranges of typical chromaticities for red, green, and blue LEDs.

FIG. 4 illustrates the combination of light-emitting elements with different dominant wavelengths to dynamically generate specific display primary chromaticities according to one embodiment of the present invention.

FIG. 5 illustrates a lighting apparatus according to one embodiment of the present invention.

FIG. 6 illustrates a backlighting apparatus according to one embodiment of the present invention.

### DETAILED DESCRIPTION OF THE INVENTION

Definitions

The term “light-emitting element” is used to define any device that emits radiation in any region or combination of regions of the electromagnetic spectrum for example, the visible region, infrared and/or ultraviolet region, when activated by applying a potential difference across it or passing a current through it, for example. Therefore a light-emitting element can have monochromatic, quasi-monochromatic, polychromatic or broadband spectral emission characteristics. Examples of light-emitting elements include semiconductor, organic, or polymer/polymeric light-emitting diodes, optically pumped phosphor coated light-emitting diodes, optically pumped nano-crystal light-emitting diodes or any other similar light-emitting devices as would be readily understood by a worker skilled in the art. Furthermore, the term light-emitting element is used to define the specific device that emits the radiation, for example a LED die, and can equally be used to define a combination of the specific device that emits the radiation together with a housing or package within which the specific device or devices are placed.

The term “chromaticity” is used to define the perceived colour impression of light according to standards of the Commission Internationale de l'Eclairage™ (CIE).

The term “gamut” is used to define the plurality of chromaticity values that a light source is able to achieve.

The term “spectral radiant flux” is used to define the radiant power per unit wavelength at a wavelength λ.

The term “sensor” is used to define an optical device having a measurable sensor parameter in response to a characteristic of incident light, such as its chromaticity or spectral intensity.

The term “dominant wavelength” of a light source refers to the wavelength of monochromatic light that, when additively mixed in suitable proportions with achromatic (“white”) light having chromaticity coordinates x=0.3333, y=0.3333, has the same chromaticity as the light source.

The term “excitation purity” of a light source is defined by the ratio NC/ND of two collinear distances on the CIE 1931 chromaticity diagram, the distance NC being that between point C representing the light source chromaticity and point N representing an achromatic light source with chromaticity coordinates x=0.3333, y=0.3333 and the distance ND being that between point N and point D on the spectral locus corresponding to the dominant wavelength of the light source.

As used herein, the term “about” refers to a +/−10% variation from the nominal value. It is to be understood that such a variation is always included in any given value provided herein, whether or not it is specifically referred to.

Unless defined otherwise, all technical and scientific terms used herein have the same meaning as commonly understood by one of ordinary skill in the art to which this invention belongs.

The present invention arises from the realization that the combination of light emitted by light-emitting elements with different chromaticities may not necessarily decrease the excitation purity of the combined light in comparison to the excitation purities of the light-emitting element chromaticities. As such, said combinations of the different chromaticities may be employed to generate display primaries with predetermined chromaticities which can be used for the purpose of backlighting a display panel for example a liquid crystal or other multicolour transmissive or reflective video display device. The present invention provides a method and apparatus for generating light having a desired chromaticity, wherein two or more light-emitting elements which emit light having a dominant wavelength different from the dominant wavelength of a desired chromaticity can be used to generate light having the desired chromaticity. In particular, the dominant wavelength of one light-emitting element is selected to be greater than that of the dominant wavelength of the desired chromaticity and the dominant wavelength of a second light-emitting element is selected to be less than the dominant wavelength of the desired chromaticity. Two or more light-emitting elements configured in this manner can be employed to generate one of each of the three or more display primaries required for a specific lighting application, for example backlighting of a display panel.

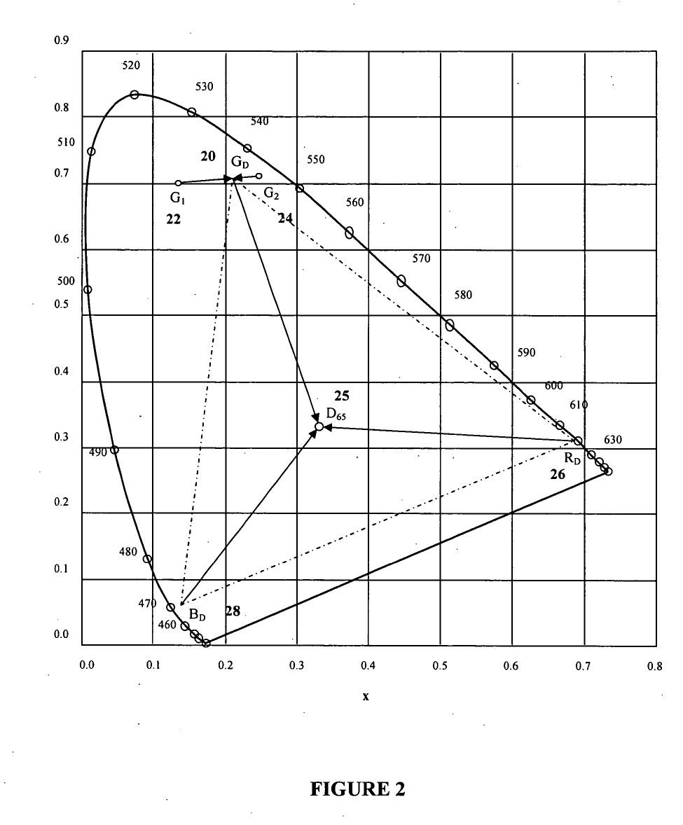

In particular, from Grassman's laws of colour additivity and with reference to FIG. 2, it can be seen that a desired display primary chromaticity G_{D} 20 can be obtained by a linear combination of luminous flux from two light-emitting elements with dominant wavelengths λ₁ and λ₂ and corresponding chromaticities G₁ 22 and G₂ 24. Further, the display primary chromaticity G_{D} 20 can be dynamically changed to compensate for detected light-emitting element chromaticity shifts by modifying the ratio of drive currents provided to one or more of the light-emitting elements. The dynamic changing of the drive currents can be enabled by an appropriately configured feedback mechanism wherein the emissions of the light-emitting elements are detected and compared with that desired and the drive current for one or more of the light-emitting elements may be adjusted accordingly. A worker skilled in the art would readily understand how to configure such an optical feedback mechanism.

In particular any colour C within the colour gamut defined by the three colours R, G, and B can be matched by the combination of these three colours in varying ratios. With further reference to FIG. 2, this figure illustrates graphically the mixing of three display primaries R_{D} 26, G_{D} 20 and B_{D} 28 to generate the D₆₅ white point 25 of a video display, for example.

Having regard to Grassman's third law of colour additivity, it can be typically defined that the resultant display primary chromaticity C, for example R_{D}, G_{D} and B_{D}, is independent of the quantities of luminous flux from the two light-emitting elements as long as the constants of proportionality d and e remain unchanged. Therefore with allowances for nonlinear relationships between light-emitting element drive current and emitted luminous flux, the display primary chromaticity C can be maintained even during dimming of the light-emitting elements.

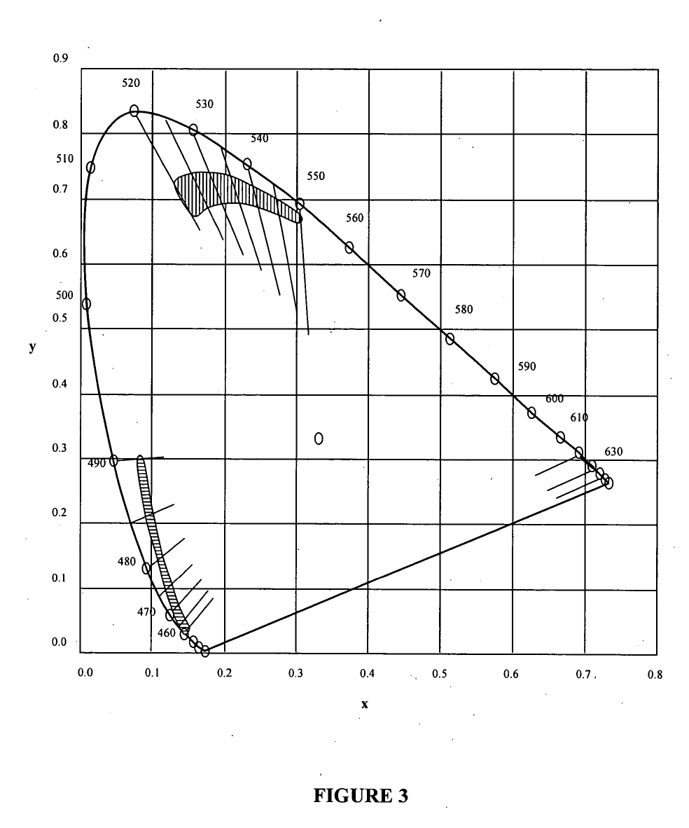

In general, any combination of light-emitting elements with dominant wavelengths within the general classification of blue, green, and red, which correspond essentially to dominant wavelength ranges of about 400 to about 490 nm, about 520 to about 550 nm, and about 620 to about 650 nm respectively, may be used to generate any desired display primary chromaticities that is within the colour gamuts defined by the light-emitting elements. As may be seen from the range of typical light-emitting element chromaticities as illustrated in FIG. 3, the display primary chromaticities will lie approximately on a straight line between the light-emitting elements with the highest and lowest dominant wavelengths, wherein this line is approximately parallel to the spectral locus. Consequently, generating a display primary chromaticity using two or more appropriately selected light-emitting elements, wherein the dominant wavelength of one light-emitting element is greater than that of the dominant wavelength of the desired display chromaticity and the dominant wavelength of the second light-emitting element is less than the dominant wavelength of the desired display chromaticity, may not significantly reduce the resultant colour gamut when compared to the colour gamut achievable with light-emitting elements that have been carefully colour-binned for generating this desired display chromaticity.

With reference to Table 1 and the associated chromaticity tolerances for SMPTE and EBU/ITU standards, and assuming a display white point of CIE D₆₅ 25 (that is, daylight with a colour temperature of 6500 Kelvin), the display primary chromaticities have approximate equivalent dominant wavelengths λ_{D} as shown in Table 2. It should be noted that the values and tolerances as defined in Table 2, are approximate as dominant wavelength is defined graphically rather than analytically by CIE.

TABLE 2

| Standard | Red (λ_{D}) | Green (λ_{D}) | Blue (λ_{D}) |
|---|---|---|---|
| SMPTE C | 606 ± 2 nm | 550 ± 2 nm | 465 ± 5 nm |
| EBU/ITU | 609 ± 2 nm | 548 ± 1 nm | 464 ± 5 nm |

Noting that light-emitting element manufacturers typically colour bin their products within ranges of about ±5 nm, it is evident that the binning requirements for red and green light-emitting elements exceed the SMPTE C and EBU/ITU industry standards by factors of about two and five times, respectively.

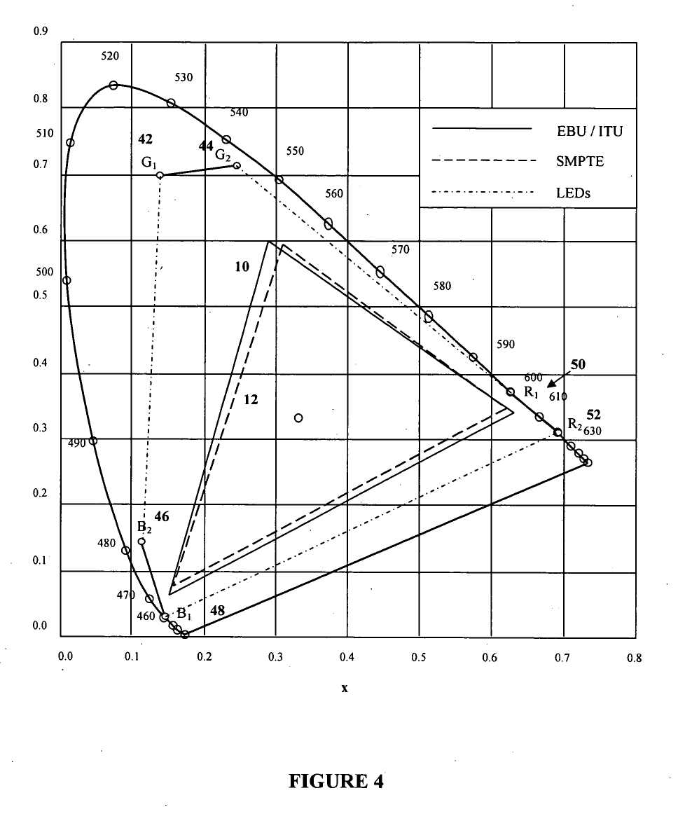

As illustrated in FIG. 4, however, Grassman's second law allows a plurality of light-emitting elements with different chromaticities, as indicated by their dominant wavelengths, to generate display primary chromaticities with the necessary tolerances as required by SMPTE and EBU/ITU standards. For example, a combination of two light-emitting elements with dominant wavelengths of G₃=520 nm 42 and G₄=540 nm 44 is capable of generating a green display primary that meets the chromaticity requirements of either standard. Depending on the drive currents applied to the light-emitting elements, the colour gamut achievable with three light-emitting element pairs namely, {R₁ 50, R₂ 52 }, {G₃ 42, G₄ 44 }, and {B₁ 46, B₂ 48 } can be determined by the hexagonal figure bounded by the light-emitting element chromaticities. As may be seen from FIG. 4, this colour gamut encompasses both the SMPTE and EBU/ITU display colour gamuts without the need for precise colour binning of the LEDs.

In general, any combination of red, green, or blue light-emitting elements may be employed to respectively generate a red, green, or blue display primary if the linear combination of their colours encompasses the chromaticity of the desired display primary, which can be defined for example by Grassman's second law as defined by Equation 2. In one embodiment of the present invention, the light-emitting elements for generation of a desired display primary are selected such that the constants of proportionality for each light-emitting element colour and by association their drive currents, be approximately equal, thereby substantially maximizing the efficient usage of each light-emitting element. For example, it is conversely undesirable to choose a set of light-emitting elements for generation of a desired display primary wherein the luminous flux contribution of one or more of the light-emitting elements is significantly less than the remainder of the light-emitting elements in the set of light-emitting elements.

In one embodiment, two light-emitting elements are employed to generate a given display primary, the dominant wavelength of one of the light-emitting elements is about m nanometers less than the display primary dominant wavelength and the dominant wavelength of the other light-emitting element is about m nanometers greater than the display primary dominant wavelength.

In another embodiment of the present invention, when three light-emitting elements are employed to generate a given display primary, the dominant wavelength of two light-emitting elements is about 2 m nanometers greater than the display primary dominant wavelength and the dominant wavelength of the third light-emitting element is about m nanometers less than the display primary dominant wavelength.

In an alternate embodiment, when three light-emitting elements are employed to generate a given display primary, the dominant wavelength of two light-emitting elements is about 2 m nanometers less than the display primary dominant wavelength and the dominant wavelength of the third light-emitting element is about m nanometers greater than the display primary dominant wavelength.

In a further embodiment, when three light-emitting elements are employed to generate a given display primary, the dominant wavelength of one light-emitting elements is about 2 m nanometers greater than the display primary dominant wavelength and the dominant wavelength of the second light-emitting elements is about 2 m nanometers less than the display primary dominant wavelength, and that the dominant wavelength of the third light-emitting element is either about m nanometers less than or greater than the display primary dominant wavelength.

As would be understood, for the above embodiments, additional light-emitting elements can be further used for the generation of a given display primary.

Furthermore, for the above embodiments, the parameter m is selected to be between 0.1 and 50, between 0.1 and 25, between 0.1 and 10, between 0.1 and 5 or between 0.1 and 2. As would be readily understood by a worker skilled in the art, this parameter can be selected to be within other ranges without departing from the scope of the present invention.

As is known to a worker skilled in the art, the dominant wavelength of a light-emitting element is temperature-dependent, and as such it is necessary to monitor the light-emitting element chromaticities in order to provide for dynamic adjustment of the light-emitting element drive currents in order to maintain a desired chromaticity of the output light. A worker skilled in the art would readily understand how to set up an appropriate sensor system for this purpose, for example a single or multi-photosensor or photodiode array or the like for integration into an appropriately configured feedback loop.

For example, a feedback loop can be configured such that luminous intensity and chromaticity of light output by a combination of two or more light emitting elements can be determined by an optical sensor, for example a photodiode. This optical sensor can provide signals to a control system, for example a computing device or microprocessor, representative of these detected characteristics of the output light. The controller can subsequently be programmed to evaluate drive signals for transmission to the two or more light-emitting elements, wherein these drive signals are evaluated based on the detected light characteristics and the operational characteristics of the two or more light-emitting elements.

Furthermore, the luminous intensity of light-emitting elements is however dependent on their spectral distribution, junction temperature, drive current, non-linear luminous flux output characteristics, peak wavelength shifting and spectral broadening characteristics, device ageing and manufacturing tolerances which include for example binning for peak wavelength, luminous intensity and forward voltage. As such a control system for such a lighting system would include optical feedback from a sensor that monitors both colour and intensity in addition to operational characteristics of the light-emitting elements, for example junction temperature or other characteristics as would be readily understood by a worker skilled in the art.

The control system can provide operational control of the light-emitting elements integrated into an embodiment of the present invention can be energized using for example Pulse Width Modulation (PWM), Pulse Code Modulation (PCM) or any other energizing manner as would be readily understood by a worker skilled in the art.

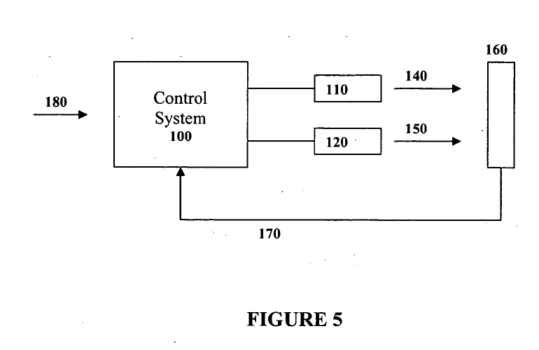

FIG. 5 illustrates a lighting apparatus according to one embodiment of the present invention, wherein the lighting apparatus is for generating light having a desired primary chromaticity. The lighting apparatus comprises one or more first light-emitting elements 110 which generate light 140 having a first dominant wavelength and one or more second light-emitting elements 120 for generating light 150 having a second dominant wavelength. The dominant wavelength of the light generated by the first light-emitting element is greater than the dominant wavelength of the desired primary chromaticity and the dominant wavelength of the light generated by the second light emitting element is less than the dominant wavelength of the desired primary chromaticity. In this manner, through appropriate control of the operation of the first and second light emitting elements, the combination of the light generated thereby can generate light having the desired primary chromaticity.

With further reference to FIG. 5, a optical measurement device 160 provides for the detection of the luminous intensity and the chromaticity of the combined light, wherein this the detected information can be feedback 170 to a control system 100 thereby providing a means for adjustment of the operational characteristics of the light-emitting elements 110 and 120 for generation of light having the desired chromaticity. In this manner, changes in the operational characteristics of the light-emitting elements or changes in the chromaticity or luminous intensity of the output light can be accounted for during operation of the lighting apparatus. The lighting apparatus is adapted to be connected to a source of power 180 thereby providing for the activation of the light-emitting elements.

In one embodiment of the present invention, the lighting apparatus comprises one or more third light-emitting elements for generating light having a third dominant wavelength, wherein the third dominant wavelength is either less than or greater than the dominant wavelength of the desired primary chromaticity.

As would be known, the frequency at which the feedback of detected light characteristics is transmitted to the control system must be greater than the fusion frequency which is about 100 Hz in order to avoid perceptible flicker of the output light.

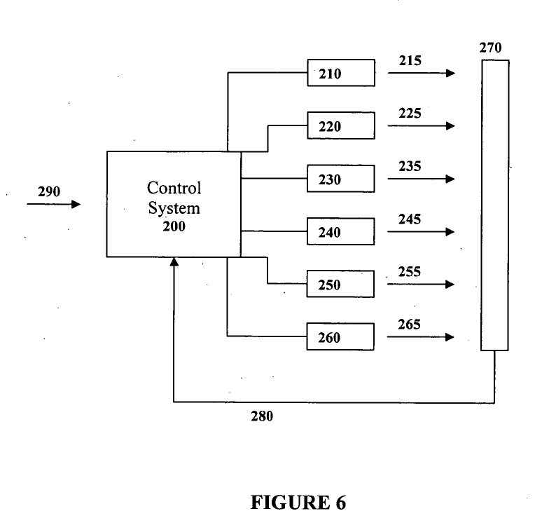

FIG. 6 illustrates a backlighting apparatus according to one embodiment of the present invention. Each of the three display primaries are generated by two or more light emitting elements wherein the combination of the light output by the six or more light emitting elements generates light having a desired luminous intensity and chromaticity. Light-emitting elements 210 and 220 can be configured to such that they emit light 215 and 225 having a dominant wavelength greater and less than the dominant wavelength of a first primary, respectively. Light-emitting elements 230 and 240 can be similarly configured to generate a second primary and light-emitting elements 250 and 260 can be similarly configured to generate a third primary. Through the sampling of the luminous intensity and chromaticity of the light generated by the combination of the output light 215, 225, 235, 245, 255 and 265 from the light-emitting elements by an measurement system 270, data can be fed back 280 to a control system 200, thereby enabling appropriate control of the light-emitting elements in the backlighting apparatus. The backlighting apparatus is adapted for connection to a source of power 290 thereby enabling activation of the light-emitting elements.

In one embodiment of the present invention, the backlighting apparatus comprises one or more secondary light-emitting elements for aiding in the generating of one or more of the first primary, second primary or third primary. The dominant wavelength of the secondary light-emitting element can be either greater than or less than the dominant of wavelength of the selected primary with which the secondary light-emitting element is associated. Secondary light-emitting elements can optionally be provided for the generation of each of the primaries.

It is obvious that the foregoing embodiments of the invention are exemplary and can be varied in many ways. Such present or future variations are not to be regarded as a departure from the spirit and scope of the invention, and all such modifications as would be obvious to one skilled in the art are intended to be included within the scope of the following claims.

The disclosure of all patents, publications, including published patent applications, and database entries referenced in this specification are specifically incorporated by reference in their entirety to the same extent as if each such individual patent, publication, and database entry were specifically and individually indicated to be incorporated by reference.

I claim:

1. A method for generating light having a desired primary chromaticity having a dominant wavelength, said method comprising the steps of:
a) providing one or more first light-emitting elements for generating first light having a first dominant wavelength, said first dominant wavelength being greater than the dominant wavelength of the desired primary chromaticity;
b) providing one or more second light-emitting elements for generating second light having a second dominant wavelength, said second dominant wavelength being less than the dominant wavelength of the desired primary chromaticity; and
c) driving said one or more first light-emitting elements and said one or more second light-emitting elements, wherein combining the first light and second light creates light having the desired primary chromaticity.

2. The method according to claim 1, further comprising providing one or more third light-emitting elements for generating third light having a third dominant wavelength, said third dominant wavelength being either greater than or less than the dominant wavelength of the desired primary chromaticity.

3. The method according to claim 1, wherein the first dominant wavelength is greater than the dominant wavelength of the desired primary chromaticity by M nanometers and the second dominant wavelength is less than the dominant wavelength of the desired primary chromaticity by M nanometers.

4. The method according to claim 2, wherein the first dominant wavelength and the third dominant wavelength are greater than the dominant wavelength of the desired primary chromaticity by 2M nanometers and the second dominant wavelength is less than the dominant wavelength of the desired primary chromaticity by M nanometers.

5. The method according to claim 2, wherein the second dominant wavelength and the third dominant wavelength are less than the dominant wavelength of the desired primary chromaticity by 2M nanometers and the first dominant wavelength is greater than the dominant wavelength of the desired primary chromaticity by M nanometers.

6. The method according to claim 2, wherein the first dominant wavelength is greater than the dominant wavelength of the desired primary chromaticity by 2M nanometers, the second dominant wavelength is less than the dominant wavelength of the desired primary chromaticity by 2M nanometers and the third dominant wavelength is greater than or less than the dominant wavelength of the desired primary chromaticity by M nanometers.

7. An apparatus for generating light having a desired primary chromaticity having a dominant wavelength, said apparatus comprising:
a) one or more first light-emitting elements for generating first light having a first dominant wavelength, said first dominant wavelength being greater than the dominant wavelength of the desired primary chromaticity;
b) one or more second light-emitting elements for generating second light having a second dominant wavelength, said second dominant wavelength being less than the dominant wavelength of the desired primary chromaticity;
c) a feedback system for monitoring a combination of the first light and the second light, said feedback system for generating feedback signals based thereon; and
d) a control system operatively connected to the feedback system for receiving the feedback signals and for controlling activation of said one or more first light-emitting elements and one or more second light-emitting elements, wherein said control system activates the one or more first light emitting elements and the one or more second light-emitting elements in order that the combination of the first light and the second light creates light having the desired primary chromaticity;
wherein the apparatus is adapted for connection to a source of power for activation of the one or more first light-emitting element and one or more second light-emitting elements.

8. The apparatus according to according to claim 7, further comprising one or more third light-emitting elements for generating third light having a third dominant wavelength, said third dominant wavelength being either greater than or less than the dominant wavelength of the desired primary chromaticity.

9. The apparatus according to claim 7, wherein the first dominant wavelength is greater than the dominant wavelength of the desired primary chromaticity by M nanometers and the second dominant wavelength is less than the dominant wavelength of the desired primary chromaticity by M nanometers.

10. The apparatus according to claim 8, wherein the first dominant wavelength and the third dominant wavelength are greater than the dominant wavelength of the desired primary chromaticity by 2M nanometers and the second dominant wavelength is less than the dominant wavelength of the desired primary chromaticity by M nanometers.

11. The apparatus according to claim 8, wherein the second dominant wavelength and the third dominant wavelength are less than the dominant wavelength of the desired primary chromaticity by 2M nanometers and the first dominant wavelength is greater than the dominant wavelength of the desired primary chromaticity by M nanometers.

12. The apparatus according to claim 8, wherein the first dominant wavelength is greater than the dominant wavelength of the desired primary chromaticity by 2M nanometers, the second dominant wavelength is less than the dominant wavelength of the desired primary chromaticity by 2M nanometers and the third dominant wavelength is greater than or less than the dominant wavelength of the desired primary chromaticity by M nanometers.

13. A backlighting apparatus comprising:
a) one or more first light-emitting elements for generating first light having a first dominant wavelength, said first dominant wavelength being greater than a desired first primary dominant wavelength and one or more second light-emitting elements for generating second light having a second dominant wavelength, said second dominant wavelength being less than the desired first primary dominant wavelength;
b) one or more third light-emitting elements for generating third light having a third dominant wavelength, said third dominant wavelength being greater than a desired second primary dominant wavelength and one or more fourth light-emitting elements for generating fourth light having a fourth dominant wavelength, said fourth dominant wavelength being less than the desired second primary dominant wavelength;
c) one or more fifth light-emitting elements for generating fifth light having a fifth dominant wavelength, said fifth dominant wavelength being greater than a desired third primary dominant wavelength and one or more sixth light-emitting elements for generating sixth light having a sixth dominant wavelength, said sixth dominant wavelength being less than the desired third primary dominant wavelength;
d) a feedback system for monitoring a combination of the first light, second light, third light, fourth light, fifth light and sixth light, said feedback system for generating feedback signals based thereon; and
e) a control system operatively connected to the feedback system for receiving the feedback signals and for controlling activation of said first, second, third, fourth, fifth and sixth light-emitting elements, wherein said control system activates the first, second, third, fourth, fifth and sixth light emitting elements in order that the combination of the first, second, third, fourth, fifth and sixth light creates light having a desired chromaticity;
wherein the backlighting apparatus is adapted for connection to a source of power for activation of said first, second, third, fourth, fifth and sixth light-emitting elements.
